(19) United States
(12) Patent Application Publication
(10) Pub. No.: US 2025/0132592 A1
(43) Pub. Date: Apr. 24, 2025

(54) MULTI-PATH BATTERY CHARGER

(71) Applicant: GREEN CUBES TECHNOLOGY, LLC, Kokomo, IN (US)

(72) Inventors: UGAITZ IRURET AGOYENA, Zurich (CH); NICOLA CINAGROSSI, Uster (CH)

(73) Assignee: GREEN CUBES TECHNOLOGY, LLC, Kokomo, IN (US)

(21) Appl. No.: 18/834,470

(22) PCT Filed: Jun. 21, 2022
(86) PCT No.: PCT/US2022/034219

§ 371 Date: Jul. 30, 2024

Related U.S. Application Data
(60) Provisional application No. 63/315,267, filed on Mar. 1, 2022.

(51) Int. Cl. H02J 7/04

(52) U.S. Cl. CPC H02J 7/04; H02J 2207/20

(57) ABSTRACT

A multi-path charger having multiple controllable current sources connected in parallel, each current source is in series with its own current sensor, and both are dimensioned based on the maximum power and current divided by the number of the controlled current sources. The number of used current sources depends on the load. With a light load, only one current source is on while the rest is turned off. As the load increases, more current sources are switched on to supply power to the load. By that, the power efficiency and current measurement accuracy are significantly improved with a light load. Moreover, the multi-path charger can be used with multi-output with each output supplied by several parallel current sources.

### PRIORITY

The present patent application is related to, and claims the priority benefit of, U.S. Provisional Patent Application Ser. No. 63/315,267, filed on Mar. 1, 2022, the contents of which are hereby incorporated by reference in their entirety into this disclosure.

### BACKGROUND

In the last few years, battery chargers have become widely used in our lives. Battery charger usage includes common activities such as charging multiple electronics from small consumer products like mobile phones to large batteries such as car batteries. The efficiency of charging is rapidly increasing every year, but this efficiency is primarily calculated with high loads as the power loss is considered small compared to the large amount of power supplied by the charger. On the other hand, charger efficiency significantly decreases at low load (light load).

As most charging losses are fixed losses, such as semiconductor switching losses and magnetic losses, these losses become more noticeable under light load conditions. Moreover, the current measurement accuracy and precision at light load is low because the current measurement sensor is also dimensioned for the maximum current. Most of the accuracy issues come from.

Existing chargers operate suboptimally during light load operations when considering conversion efficiency and current control accuracy and precision. This leads to large errors in current delivered to the battery which results in early disconnection from the battery and a reduction in the overall energy accumulated in the battery cells. The lower efficiency of existing chargers also reduces the accumulative energy level of the battery versus the energy provided by the energy source. As such, there is a need for a charger that is efficient at low load, and such a charger would be well received in the marketplace.

### BRIEF SUMMARY

In an exemplary embodiment of the present invention, a multi-path charger has multiple controllable current sources connected in parallel. Each current source is in series with its own current sensor and both are dimensioned based on the maximum power and current divided by the number of the controlled current sources. The number of the activated current sources depends on the load. For example, under light load, only one current source is on while the rest are turned off. As the load increases, more current sources are switched on to supply power to the load. In this manner, the power efficiency and current measurement accuracy are significantly improved under light load.

In another exemplary embodiment of the present invention, a multi-path charger comprises: an input power provided to a charger; at least two controllable current sources connected to the input power in parallel; a current measurement sensor connected to each of the at least two controllable current sources such that each of the at least two controllable current sources has an associated current measurement sensor to measure an output current of each controllable current source; a load to receive power from the at least two controllable current sources; a load management system configured to determine set points of the at least two controllable current sources based on a status of the load; and a controller configured to control the at least two controllable current sources based on information from the load management system; wherein each of the at least two current sources is dimensioned to provide a portion of a maximum power of the charger in order to increase charger efficiency at a light load.

In a further embodiment of the present invention, the input power is AC power.

In a further embodiment of the present invention, the output current of each controllable current source combines to a single output received by the load.

In a further embodiment of the present invention, each of the at least two current sources and their associated current measurement sensors are dimensioned based on the maximum power of the charger divided by a total number of the at least two controllable current sources.

In a further embodiment of the present invention, each current sensor is dimensioned based on a maximum current of the charger divided by a total number of the at least two controllable current sources.

In a further embodiment of the present invention, each current sensor is dimensioned to accurately sense the output current of its associated current source to increase current measurement accuracy at light load.

In a further embodiment of the present invention, the controller reads the output current detected by the current measurement sensors and adjusts the current of the at least two current sources based on information from the load management system.

In a further embodiment of the present invention, the controller and each current measurement sensor are part of a controller circuit which measures and adjusts the output current of each current source.

In a further embodiment of the present invention, the at least two controllable current sources are configured to be activated and deactivated independently of each other by the controller.

In a further embodiment of the present invention, the at least two controllable current sources can be switched on or off to increase the charger efficiency at a light load.

In a further embodiment of the present invention, each of the at least two controllable current sources can be activated to become an active current source providing power to the load, and the active current sources are controlled to equally contribute to the output power.

In a further embodiment of the present invention, each of the at least two controllable current sources has a maximum efficiency at which it delivers power.

In a further embodiment of the present invention, at least one of the at least two controllable current sources is controlled to operate at its maximum efficiency.

In a further embodiment of the present invention, the controller controls the at least two controllable current sources to minimize the input power needed to meet a power demand of the load and therefore maximize the overall efficiency.

In a further embodiment of the present invention, the at least two controllable current sources are semiconductor switching converters that convert the AC input power to DC power.

In a further embodiment of the present invention, the at least two controllable current sources comprise at least four controllable current sources, the at least four controllable current sources combine to form at least two power outputs, wherein each of the at least two power outputs is supplied by two or more of the at least four controllable current sources connected in parallel; and wherein a first power output of the at least two power outputs is connected to the load and a second power output of the at least two power outputs is connected to a second load.

In a further embodiment of the present invention, the load management system is configured to determine the set points of the two or more of the at least four controllable current sources connected to the load; wherein a second load management system is configured to determine the set points of the two or more of the at least four controllable current sources connected to the second load; and wherein the controller is configured to control the at least four controllable current sources based on information from the load management system and the second load management system.

In another embodiment of the present invention, a method of using the described multi-path charger comprises the steps of: providing the input power to the multi-path charger; connecting the input power to the at least two controllable current sources of the multi-path charger connected in parallel, wherein each of the at least two controllable current sources are dimensioned to provide a portion of the maximum power of the multi-path charger; and activating a first current source of the at least two controllable current sources to provide power to the load connected thereto; wherein the power is provided to the load through a first output.

In another embodiment of a method of using the described multi-path charger, a second controllable current source of the at least two controllable current sources is not activated.

In a further embodiment of a method of using the described multi-path charger, the steps also comprise activating the second current source to provide power to a connected load, wherein each of the first current source and the second current source provide a portion of a total power demand from the load.

In another embodiment of a method of using the described multi-path charger, the at least two activated current sources equally contribute to meeting the power demand.

In a further embodiment of a method of using the described multi-path charger, the steps also comprise activating all of the at least two controllable current sources, and all of the at least two controllable current sources equally contribute to meeting the power demand.

In another embodiment of a method of using the described multi-path charger, the equal contribution of the at least two controllable currents sources is controlled by a controller.

In another embodiment of a method of using the described multi-path charger, one of the at least two activated current sources contributes more power to meet the power demand than the other activated current source of the at least two activated current sources.

In a further embodiment of a method of using the described multi-path charger, the steps also comprise the steps of allowing the first current source to reach a maximum efficiency; and the step of activating the second current source further comprises the step of activating the second current source once the first current source has reached its maximum efficiency.

In a further embodiment of a method of using the described multi-path charger, the steps also comprise the step of deactivating the second current source in response to a reduction in the power demand of the load.

In a further embodiment of a method of using the described multi-path charger, the steps also comprise increasing the power demand of the load; operating the second current source at a second maximum efficiency; and activating a third current source to provide power to the connected load once the second current source is operating at a second maximum efficiency.

In a further embodiment of a method of using the described multi-path charger, the steps also comprise adjusting the power provided by the activated current sources to minimize the input power needed to meet the power demand of the load, thus maximizing the overall efficiency.

In a further embodiment of a method of using the described multi-path charger, the steps also comprise the step of utilizing the controller and the load management system connected to the load to analyze and determine an output current and current at the battery.

In a further embodiment of a method of using the described multi-path charger, the steps also comprise connecting the input power to a second group of at least two controllable current sources of the multi-path charger connected in parallel, wherein each of the second group of at least two controllable current sources are dimensioned to provide a portion of the maximum power of the multi-path charger; and activating a first current source of the second group of at least two controllable current sources to provide a second power to a connected second load; and wherein the second power is provided to the second load through a second output.

In an exemplary embodiment, a method of using a multi-path charger to charge an item comprises the steps of: providing an input power to a multi-path charger; connecting the input power to at least two controllable current sources of the multi-path charger connected in parallel, wherein each of the at least two controllable current sources are dimensioned to provide a portion of the maximum power of the multi-path charger; activating a first current source of the at least two controllable current sources to provide a power to a connected load; and wherein the power is provided to the load through a first output.

In another embodiment of a method of using the described multi-path charger, a second controllable current source of the at least two controllable current sources is not activated.

In a further embodiment of a method of using the described multi-path charger, the steps also comprise activating the second current source to provide power to a connected load, wherein each of the first current source and the second current source provide a portion of a total power demand from the load.

In another embodiment of a method of using the described multi-path charger, the at least two activated current sources equally contribute to meeting the power demand.

In a further embodiment of a method of using the described multi-path charger, the steps also comprise the step of activating all of the at least two controllable current sources, and all of the at least two controllable current sources equally contribute to meeting the power demand.

In another embodiment of a method of using the described multi-path charger, the equal contribution of the at least two controllable currents sources is controlled by a controller.

In another embodiment of a method of using the described multi-path charger, one of the at least two activated current sources contributes more power to meet the power demand than the other activated current source of the at least two activated current sources.

In a further embodiment of a method of using the described multi-path charger, the steps also comprise the step of activating the first current source further comprises the steps of allowing the first current source to reach a maximum efficiency; and the step of activating the second current source further comprises the step of activating the second current source once the first current source has reached its maximum efficiency.

In a further embodiment of a method of using the described multi-path charger, the steps also comprise the step of deactivating the second current source in response to a reduction in the power demand of the load.

In a further embodiment of a method of using the described multi-path charger, the steps also comprise increasing the power demand of the load; operating the second current source at a second maximum efficiency; and activating a third current source to provide power to the connected load once the second current source is operating at a second maximum efficiency.

In a further embodiment of a method of using the described multi-path charger, the steps also comprise adjusting the power provided by the activated current sources to minimize the input power needed to meet the power demand of the load, thus maximizing the overall efficiency.

In a further embodiment of a method of using the described multi-path charger, the steps also comprise utilizing a controller and a load management system connected to the load to analyze and determine an output current and current at the battery.

In a further embodiment of a method of using the described multi-path charger, the steps also comprise connecting the input power to a second group of at least two controllable current sources of the multi-path charger connected in parallel, wherein each of the second group of at least two controllable current sources are dimensioned to provide a portion of the maximum power of the multi-path charger; and activating a first current source of the second group of at least two controllable current sources to provide a second power to a connected second load; and wherein the second power is provided to the second load through a second output.

In a embodiment of a method of using the described multi-path charger, the steps also comprise: providing an input power to a multi-path charger; connecting the input power to a first group of at least two controllable current sources connected in parallel and a second group of at least two controllable current sources connected in parallel; activating a number of the current sources of the first group of at least two controllable current sources to provide power to a connected first load, wherein each of the first group of the at least two controllable current sources are dimensioned to provide a portion of the maximum power of the multi-path charger; and activating a number of the current sources of the second group of at least two controllable current sources to provide power to a connected second load, wherein each of the second group of the at least two controllable current sources are dimensioned to provide a portion of the maximum power of the multi-path charger, wherein the power is provided through a second output.

In another embodiment of a method of using the described multi-path charger, the activated number of current sources of the first group of at least two controllable current sources contribute equally to meeting a power demand of the first load.

In a further embodiment of a method of using the described multi-path charger, the steps also comprise the step of activating a first current source, allowing the first current source to reach a maximum efficiency; and activating the second current source once the first current source has reached its maximum efficiency.

In a further embodiment of a method of using the described multi-path charger, the steps also comprise the step of adjusting the power provided by the first group of activated current sources to minimize the input power needed to meet the power demand of the first load, thus maximizing the overall efficiency.

In another embodiment of the present invention, a multi-path charger comprises: a single input power provided to the charger; a first group of at least two controllable current sources connected in parallel, each of the first group of at least two current sources having an associated current measurement sensor to measure an output current of the associated current source, wherein the first group of at least two controllable current sources provides a first power output; and a second group of at least two controllable current sources connected in parallel, each of the second group of at least two current sources having an associated current measurement sensor to measure an output current of the associated current source, wherein the second group of at least two controllable current sources provides a second power output; wherein the first power output is connected to a first load and the second power output is connected to a second load; wherein a first load management system is connected to the first load and a second load management system is connected to the second load; wherein a controller controls both the first group of at least two current sources and the second group of at least two current sources based on information from the first and second load management systems and the current measurement sensors; and wherein the first group of at least two current sources and the second group of at least two current sources are dimensioned to provide a portion of a maximum power of the charger in order to increase the charger efficiency at a light load.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of the present disclosure taken in conjunction with the accompanying drawings, wherein:

FIG. 1 shows a schematic of a single-path charger.

FIG. 2 shows a graph of a single-path charger's efficiency.

FIG. 3 shows a graph of a single-path charger's current measurement error.

FIG. 4 shows a schematic of a multi-path charger with a single output.

FIG. 5 shows a graph of a multi-path charger's efficiency.

FIG. 6 shows a graph of a multi-path charger's current measurement error.

FIG. 7 shows a graph of a multi-path charger's efficiency curves with its current sources running at their maximum efficiency.

FIG. 8 shows a schematic of a multi-path charger with multiple outputs.

As such, an overview of the features, functions and/or configurations of the components depicted in the figures will now be presented. It should be appreciated that not all the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding the principles of the present disclosure, reference will now be made to the embodiments illustrated in the drawings, and specific language will be used to describe the same. It will nevertheless be understood that no limitation of the scope of this disclosure is thereby intended.

Chargers are used to recharge batteries or provide power to a load. Over the last decade, many technologies have been used to increase the charger's efficiency. However, most of these chargers (single-path chargers) measure the efficiency while at high load in order to reduce the ratio of fixed losses to the total power delivered. Meanwhile, the real efficiency significantly drops at low load.

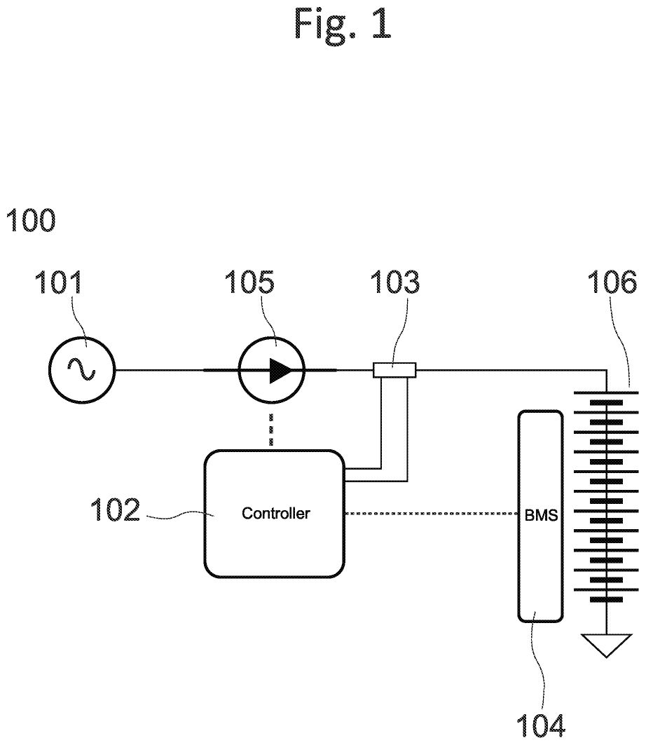

In general, a single-path charger 100 can be modeled as: an AC power source 101 to provide power to the battery 106, a single controllable current source 105 to convert the AC power to DC power and to control the amount of current/power delivered to the battery 106, and a battery management system (BMS) 104 that determines the current/power set points based on the battery capacity, state of charge (SoC), temperature, cell chemistry, etc. The BMS may act as a master and determines the value of the current to be delivered to the battery. A single-path charger may also include a control circuit 102 and a current measurement sensor 103 to control and fine tune the current delivered to the battery 106 as shown in FIG. 1. The controllable current source 105 comprises a semiconductor switching converter that converts the AC power from the power supply 101 to the DC power supplied to the battery 106. The controller circuit 102 measures the output current through the current measurement sensor 103 and controls the current source 105 operation based on the data sets given from the BMS 104.

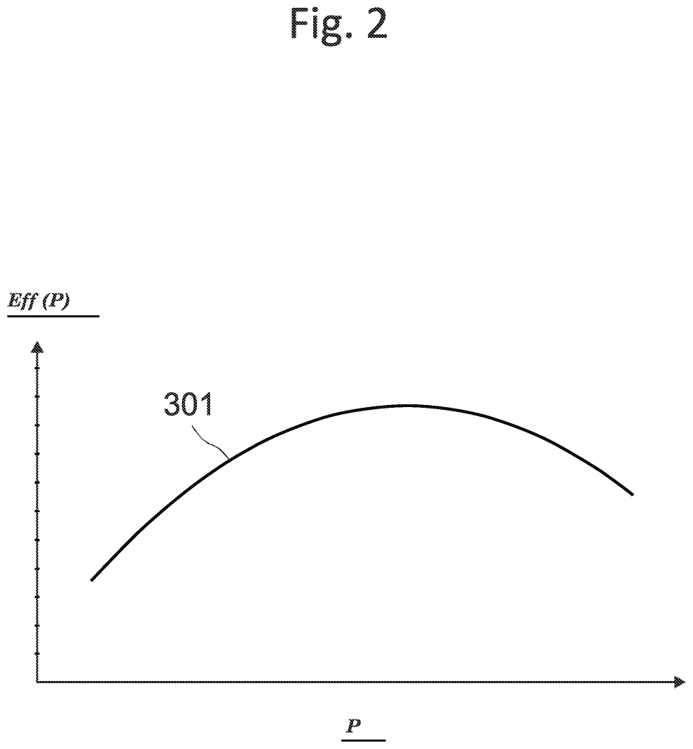

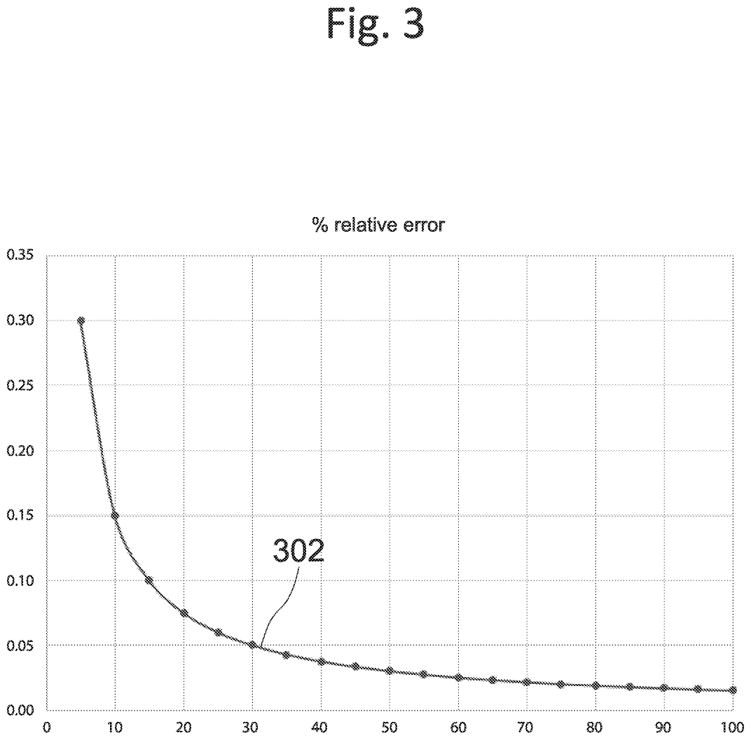

As shown in FIG. 2, when operating a switch-mode current source 105 at a light load, a significant part of the energy is lost as heat dissipation and the typical efficiency Eff(P) 301 drops significantly due to the fixed (not load-dependent) losses, which are mainly semiconductor switching losses and magnetic losses. Moreover, the current measurement sensor 103 is usually dimensioned based on the maximum current and its relative error 302 decreases when the load increases. Conversely, the precision and accuracy of the sensor will relatively decrease with the light load as shown in FIG. 3.

Components of single-path chargers are dimensioned to measure and work efficiently at large loads. A single-path charger 100 operates suboptimally during light load operations when considering conversion efficiency and current control accuracy and precision. At low loads, the misdimensioned components produce quantization errors, large noise to signal ratios, and lack of sensor precision. This leads to large errors in the current delivered to the battery which can cause an early disconnection from the battery and a reduction in the overall energy accumulated in the cells. Furthermore, lower efficiency reduces the accumulative energy level of the battery versus the energy provided by the energy source.

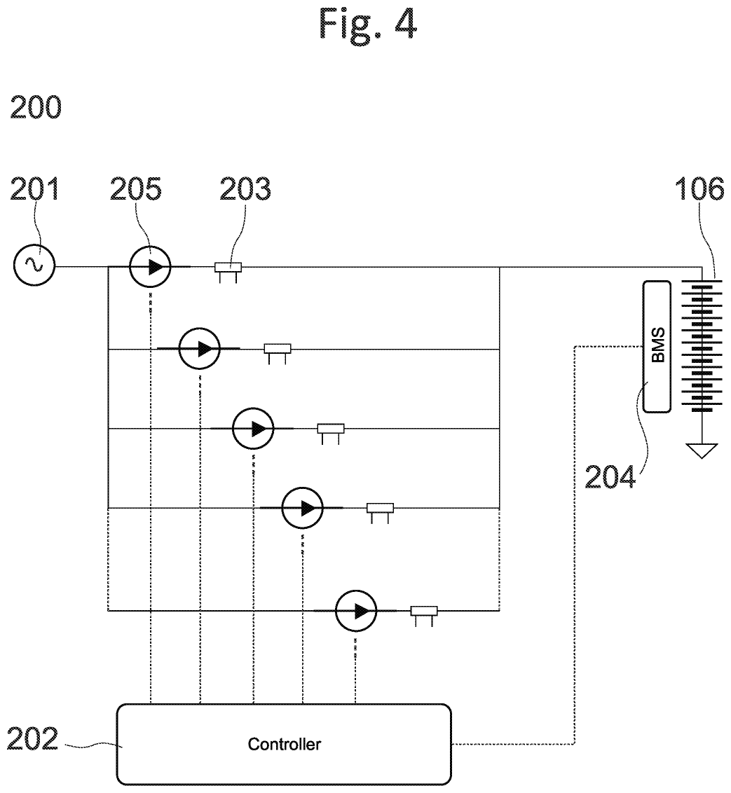

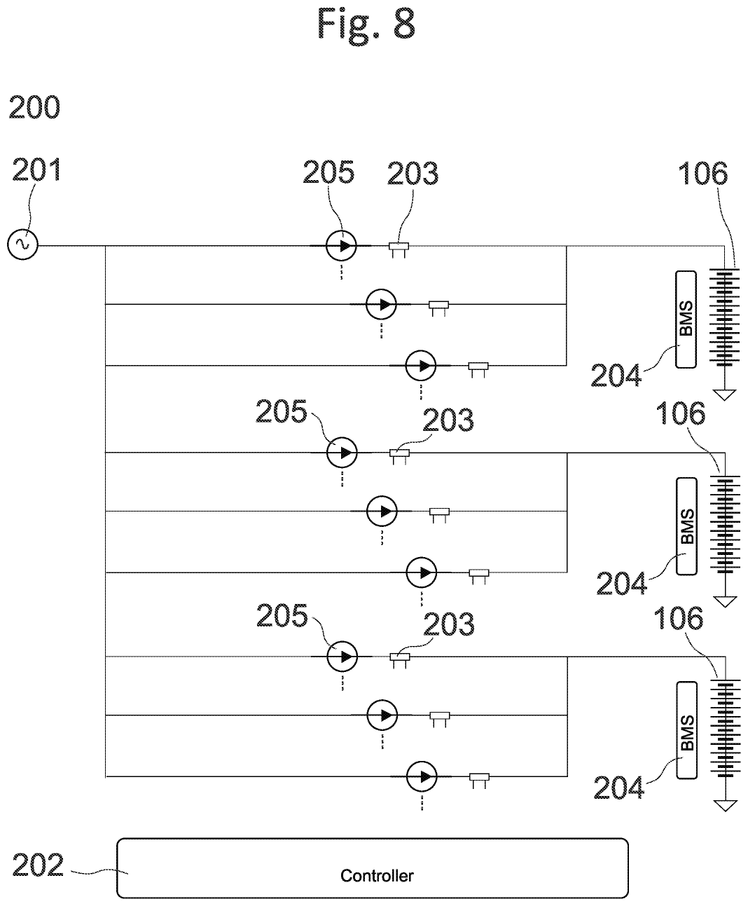

In order to improve charging efficiency and accuracy in the light load region, a multi-path charger can be used. In one embodiment of the current invention, the multi-path charger 200 comprises an AC power source 201, multi-path power delivery (each path having a controllable current source 205 and its own current sensor 203), a controller circuit 202 and a BMS 204 to control each of the controllable current sources 205, and a battery 106 to receive the power as shown in FIG. 4. As shown, the embodiment shows a single input AC source and a single output to the battery, the output being a total of the power delivered by the current sources. However multiple inputs could be envisioned, and multiple outputs, such as shown in FIG. 8 and explained further below, could also be utilized.

The components of the multi-path charger function similarly to the components of the single-path charger; the BMS 204 of the multi-path charger determines the current/power set points based on: battery capacity, SoC, temperature, cell chemistry, etc. The controller circuit 202 and current measurement sensors 203 control and fine tune the current delivered to the battery 206. The controllable current source 205 comprises a semiconductor switching converter that converts the AC power from the power supply 201 to the DC power supplied to the battery 106 while the controller circuit 202 measures the output current through the current measurement sensor 203 and controls the operation of the current sources 205 based on the data sets given from the BMS 204.

The multi-path charger can be used to increase the efficiency, accuracy, and precision during light load operations by using multiple (N) controllable current sources 205. Each current source 205 is dimensioned based on the maximum power divided by the number of current sources (N). Although five current sources and sensors are pictured in FIG. 3, the invention is not limited as such, and any number of current sources and sensors may be used. Similarly each source and sensor may have their own path. Each current source 205 is dimensioned for and provides for a fraction of the maximum power provided from the charger when activated, and each current sensor is dimensioned to the corresponding current source. Current sources can be dimensioned to specify maximum current, range of current, voltages or other such related specifications, as desired. Each one of the current sources 205 can be separately controlled (on/off) by the controller circuit to optimize efficiency and current measurement accuracy at light load. In an embodiment, the current sources may be dimensioned identically or similarly (the current sources may vary by 1%, 5%, or 10% in a given dimension), such as to facilitate equal power sharing. It is also within the scope of the invention to dimension the current sources asymmetrically or each source differently in the case of multiple sources.

The current sensors' 203 accuracy are also improved as they are also dimensioned based on the maximum current over the number of current sources, similar to the dimensioning of the current sources 205. That is, current sensors are dimensioned to work with the current sources in their respective path, and as such, would be designed to detect lower maximum currents, increasing their accuracy and precision. In addition, the current sensor 203 accuracy is also significantly improved because the signal/noise ratio is multiplied by N value (number of controllable current sources).

Compared to a single-path charger, the multi-path charger will have lower switching and magnetic losses at light loads. In a multi-path charger, at light load, some or most of the current sources will be turned off, thereby reducing these fixed losses. Furthermore, each current source is dimensioned to provide a portion of the total power so fixed switching losses per source can be reduced. In contrast a single-path charger comprises a single current source providing all of the deliverable power which must be kept activated even at light loads, and therefore the fixed losses of switching losses and magnetic losses cannot be reduced.

In an exemplary method of the current invention, at a very light load, only one current source 205 is active while the other sources are turned off, As the current demand from the load 106 increases, a second current source is turned on. At an even higher current demand, a third current source is turned on and so forth, until at the end, where current demand is highest, all N current sources will be activated. The load current is used as a thresholds to move from N−1 to N current sources 205 active (1 to 2, 2 to 3 . . . etc.) to keep the overall efficiency of the charger 200 at its maximum level. That is, at certain power demand thresholds, which may be determined by or originating from the BMS, an additional current source can be activated to meet the power demands.

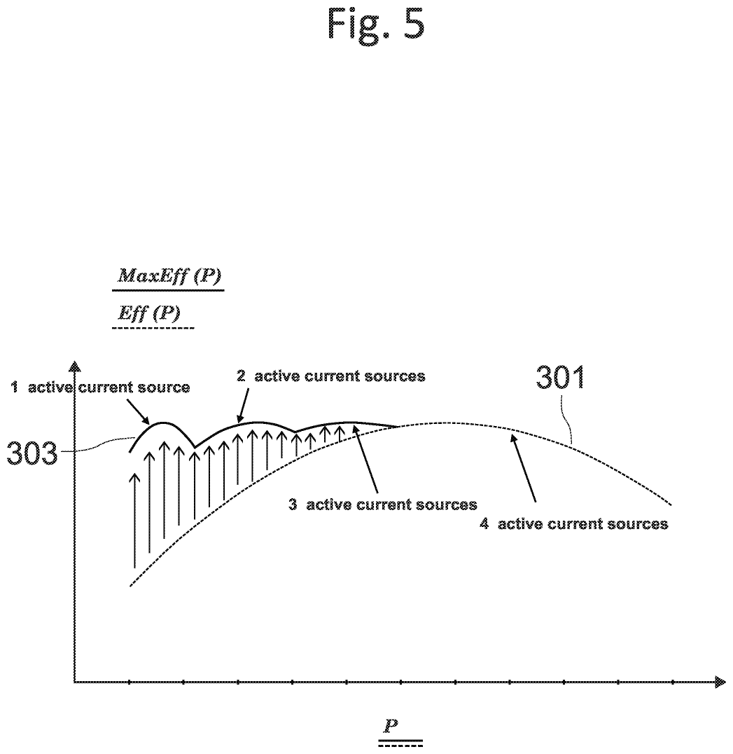

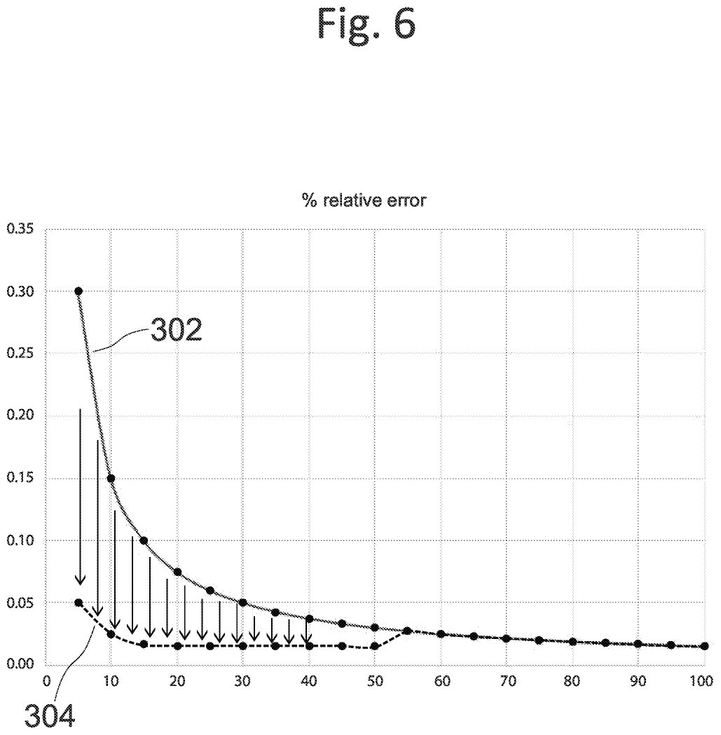

FIG. 5 shows the difference in the charger efficiency Eff(P) between the number of active current sources. With less current sources in operation, the efficiency is elevated significantly at light load 303. By that, the charger efficiency 303 at one active current source is much higher than the efficiency 301 of four active current sources at a light load. Similarly, the current sensor relative error 304 for the multi-path charger 200 is much lower than the relative error 302 of the single-path charger 100 as shown in FIG. 6. This reduction in the relative error is due to the current measurement sensor's design as each sensor is dimensioned for the maximum current over the number of current sources. As each sensor is designed for the current sources, quantization errors are reduced, and measurement is more accurate and precise.

In one of the embodiments of the current invention, an equal power sharing distribution between the active current sources 205 is ensured by a control system, which may be the control circuit or integrated therein, or separate. In this case the efficiency of a six current source multi-path charger 200 operating at 10% Pmax when only one current source is active is equal to Eff(0.1*Pmax*6/1)=Eff(0.6*Pmax). The same multi-path charger 200 operating at 20% of his rated load with two current sources active will have the efficiency equal to Eff(0.2*Pmax*6/2)=Eff(0.2*Pmax*6/2)=Eff(0.6*Pmax). In general, the efficiency formula using this method is equal to Eff(Px*N/X) where Px is the total output power, N is the total number of the current sources in the multi-path changer and X is the number of the active current sources.

Another embodiment of the current invention comprises increasing the power to each individual current source 205 to achieve their maximum efficiency point before turning on new current sources. In this case, equal power sharing between the active current sources is not ensured. The focus is on having the maximum number of current sources operating at their maximum efficiency point. In this embodiment, the thresholds for moving from N−1 active current sources to N active current sources preferably match the maximum efficiency point of each current source.

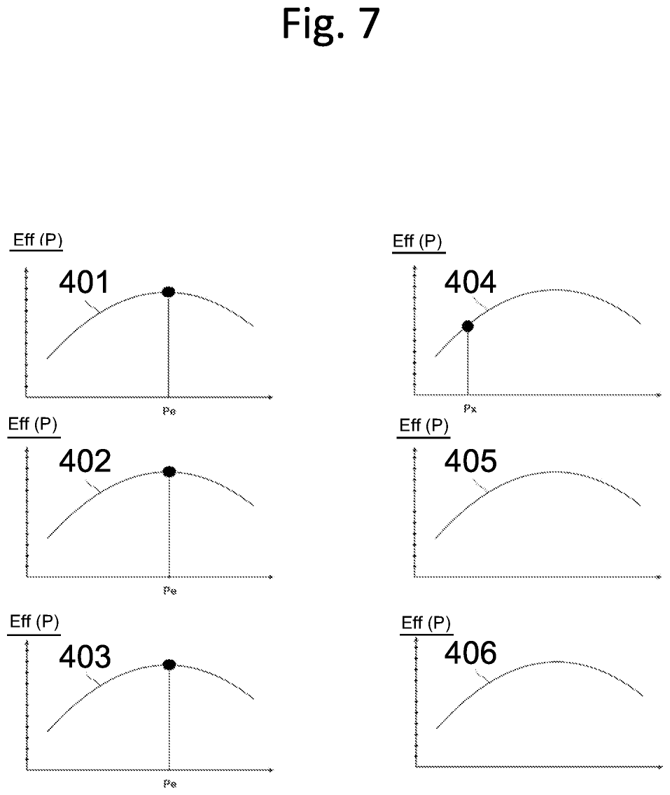

In FIG. 7, the current sources with efficiency curves 401, 402 and 403 operate at their maximum efficiency, each one of them delivering Pe (power at maximum efficiency) to the battery while the current source 404 delivers the power Px (power at any point) and 405, 406 curves shows the current sources are off. In this case, the total load power or battery power (Pbatt) is equal to 3*Pe+Px. By using this method, the general formula for load power (or battery power) is Pbatt=(X−1)*Pe+Px as long as the total power provided to the battery (load) 106 is lower than N*Pe where N is the total number of the current sources 205 in the multi-path changer 200 and X is the number of the active current sources. The overall efficiency is equal to ((X−1)*Pe+Px)*Eff(Pe)*Eff(Px)/(Eff(Px)*(X−1)*Pe+Eff(Pe)*Px). In an exemplary method, the first current source 205 is turned on and power delivery is increased until it reaches its maximum efficiency point. Then the next current source 205 is activated until the second source 205 reaches its maximum efficiency point (Pe) followed by another current source 205 until all the current sources 205 are turned on.

Where the current sources are dimensioned identically, their maximum efficiency point would be at the same level of power output and their efficiency curves would be similar. However, in the case where current sources are dimensioned differently, the efficiency curves may differ and they may have differing power outputs at maximum efficiency. Asymmetric current sources may be useful in applications where multiple known levels of power may be needed. Examples may include, and are not limited to, devices with multiple accessories, or a low-power or power saving mode, such as a “sleep” mode.

Another method of the current invention is to adjust the power sharing between the different current sources to minimize the input power needed to reach a desired output power, thus maximizing the overall efficiency. In an embodiment, the total combined efficiency over all current sources is maximized to deliver power, instead of maximizing the efficiency of each individual source or instead of activating additional current sources when the efficiency of a current source is reached. In one embodiment the controller may work with the BMS to analyze and determine the output current and current at the battery.

In another embodiment of the current invention, the multi-path charger 200 is fashioned and operates similarly to the embodiments described above, but with multiple outputs. Every output can be configured including multiple current sources in parallel as shown in FIG. 8. Like the previously described embodiments, the embodiment of FIG. 8 includes a single AC source 201. Multiple current sources 205 are connected in parallel to the AC source 201 thereby defining a multiple paths for power to flow to the output. Each current source 205 is connected to a current measurement sensor 203. Similar to the embodiments above, the current sources 205 send power along multiple paths that join into a single output.

In the embodiment of FIG. 8, the multiple current sources 205 are divided into groups, wherein each group of current sources 205 joins into a single output resulting in multiple outputs from a single AC source. FIG. 8. shows three outputs, however, it is envisioned that there could be as few as two outputs and more than three outputs. FIG. 8. also shows three current sources (and associated sensors) per group, but like the previous embodiments, there could be as few as two current sources, or more than three. As illustrated in FIG. 8, the groups have the same number of current sources 205 (and associated sensors) per group, however other embodiments within the scope of the invention could have varying amounts of current sources per group. For example, a first group may have two current sources (and associated sensors), and a second group may have four current sources (and associated sensors).

Each output is connected to a battery or load 106 which also has a BMS 204. In the embodiment of FIG. 8, a single controller operates the entire multi-path charger. The algorithms enabling and disabling the current sources as in the single output configuration are used for each output to optimize the efficiency. Each group of current sources may be operated via the methods described above to ensure efficiency. The same methods may also be applied to the charger as a whole. For example, the total efficiency of all current sources in the charger may be taken into consideration to increase the overall efficiency of all outputs, or the efficiency of each group of current sources may be analyzed for determining the best settings for output efficiency. As described above, other methods could use the maximum efficiency point of each current source as a threshold current to determine when to activate an additional current source.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and remain within the scope of the present disclosure.

1. A multi-path charger comprising:
an input power provided to a charger;
at least two controllable current sources connected to the input power in parallel;
a current measurement sensor connected to each of the at least two controllable current sources such that each of the at least two controllable current sources has an associated current measurement sensor to measure an output current of each controllable current source;
a load to receive power from the at least two controllable current sources;
a load management system configured to determine set points of the at least two controllable current sources based on a status of the load; and
a controller configured to control the at least two controllable current sources based on information from the load management system;
wherein each of the at least two current sources is dimensioned to provide a portion of a maximum power of the charger in order to increase charger efficiency at a light load.

2. (canceled)

3. The multi-path charger of claim 1, wherein the output current of each controllable current source combines to a single output received by the load.

4. The multi-path charger of claim 1, wherein each of the at least two current sources and their associated current measurement sensors are dimensioned based on the maximum power of the charger divided by a total number of the at least two controllable current sources.

5. The multi-path charger of claim 1, wherein each current sensor is dimensioned based on a maximum current of the charger divided by a total number of the at least two controllable current sources.

6. The multi-path charger of claim 1, wherein each current sensor is dimensioned to accurately sense the output current of its associated current source to increase current measurement accuracy at light load.

7. The multi-path charger of claim 1, wherein the controller reads the output current detected by the current measurement sensors and adjusts the current of the at least two current sources based on information from the load management system.

8. The multi-path charger of claim 7, wherein the controller and each current measurement sensor are part of a controller circuit which measures and adjusts the output current of each current source.

9. The multi-path charger of claim 1, wherein the at least two controllable current sources are configured to be activated and deactivated independently of each other by the controller.

10. (canceled)

11. The multi-path charger of claim 1, wherein each of the at least two controllable current sources can be activated to become an active current source providing power to the load, and the active current sources are controlled to equally contribute to the output power.

12. (canceled)

13. (canceled)

14. The multi-path charger of claim 1, wherein the controller controls the at least two controllable current sources to minimize the input power needed to meet a power demand of the load and therefore maximize the overall efficiency.

15. The multi-path charger of claim 2, wherein the at least two controllable current sources are semiconductor switching converters that convert the AC input power to DC power.

16. The multi-path charger of claim 1 wherein the at least two controllable current sources comprise at least four controllable current sources, the at least four controllable current sources combine to form at least two power outputs, wherein each of the at least two power outputs is supplied by two or more of the at least four controllable current sources connected in parallel; and
wherein a first power output of the at least two power outputs is connected to the load and a second power output of the at least two power outputs is connected to a second load.

17. The multi-path charger of claim 16 wherein the load management system is configured to determine the set points of the two or more of the at least four controllable current sources connected to the load;
wherein a second load management system is configured to determine the set points of the two or more of the at least four controllable current sources connected to the second load; and
wherein the controller is configured to control the at least four controllable current sources based on information from the load management system and the second load management system.

18. A method of using the multi-path charger of claim 1 to charge an item comprising the steps of:
providing the input power to the multi-path charger;
connecting the input power to the at least two controllable current sources of the multi-path charger connected in parallel, wherein each of the at least two controllable current sources are dimensioned to provide a portion of the maximum power of the multi-path charger; and
activating a first current source of the at least two controllable current sources to provide power to the load connected thereto;
wherein the power is provided to the load through a first output.

19. (canceled)

20. The method of claim 18 comprising the steps of:
activating the second current source to provide power to the connected load, wherein each of the first current source and the second current source provide a portion of a total power demand from the load.

21.-43. (canceled)

44. A method of using a multi-path charger to charge an item comprising the steps of:
providing an input power to a multi-path charger;
connecting the input power to a first group of at least two controllable current sources connected in parallel and a second group of at least two controllable current sources connected in parallel;
activating a number of the current sources of the first group of at least two controllable current sources to provide power to a connected first load, wherein each of the first group of the at least two controllable current sources are dimensioned to provide a portion of the maximum power of the multi-path charger; and
activating a number of the current sources of the second group of at least two controllable current sources to provide power to a connected second load, wherein each of the second group of the at least two controllable current sources are dimensioned to provide a portion of the maximum power of the multi-path charger, wherein the power is provided through a second output.

45. The method of claim 44, wherein the activated number of current sources of the first group of at least two controllable current sources contribute equally to meeting a power demand of the first load.

46. The method of claim 44, wherein the step of activating a number of the current sources of the first group of at least two controllable current sources further comprises the step of activating a first current source, allowing the first current source to reach a maximum efficiency; and
activating the second current source once the first current source has reached its maximum efficiency.

47. The method of claim 44, further comprising the step of adjusting the power provided by the first group of activated current sources to minimize the input power needed to meet the power demand of the first load, thus maximizing the overall efficiency.

48. A multi-path charger comprising:
a single input power provided to the charger;
a first group of at least two controllable current sources connected in parallel, each of the first group of at least two current sources having an associated current measurement sensor to measure an output current of the associated current source, wherein the first group of at least two controllable current sources provides a first power output; and
a second group of at least two controllable current sources connected in parallel, each of the second group of at least two current sources having an associated current measurement sensor to measure an output current of the associated current source, wherein the second group of at least two controllable current sources provides a second power output;
wherein the first power output is connected to a first load and the second power output is connected to a second load;
wherein a first load management system is connected to the first load and a second load management system is connected to the second load;
wherein a controller controls both the first group of at least two current sources and the second group of at least two current sources based on information from the first and second load management systems and the current measurement sensors; and
wherein the first group of at least two current sources and the second group of at least two current sources are dimensioned to provide a portion of a maximum power of the charger in order to increase the charger efficiency at a light load.
